(19) United States
(12) Patent Application Publication
(10) Pub. No.: US 2008/0118408 A1
(43) Pub. Date: May 22, 2008

(54) Gas generator

(75) Inventors: Kenji Numoto, Hyogo (JP); Naoki Matsuda, Hyogo (JP); Tomoharu Kobayashi, Hyogo (JP)

Correspondence Address: BIRCH STEWART KOLASCH & BIRCH, PO BOX 747, FALLS CHURCH, VA, 22040-0747, US

(73) Assignee: DAICEL CHEMICAL INDUSTRIES, LTD., Osaka-shi (JP)

(21) Appl. No.: 11/978,565

(22) Filed: Oct. 30, 2007

(30) Foreign Application Priority Data
Nov. 7, 2006 (JP) 2006-301445

(51) Int. Cl. B01J 7/00

(52) U.S. Cl. 422/167; 280/741

(57) ABSTRACT

The present invention provides a gas generator including an igniter, a gas-generating agent and a coolant/filter in a housing,
a positioning portion for the coolant/filter, which is formed in advance into a convex shape on the inward side of the housing and that is provided at least in either of the top surface or the bottom surface of the housing,
the coolant/filter being positioned by the positioning portion.

This nonprovisional application claims priority under 35 U.S.C. § 119(a) on Patent Application No. 2006-301445 filed in Japan on 7 Nov. 2006, which is incorporated by reference.

### BACKGROUND OF INVENTION

1. Field of Invention

The present invention relates to a gas generator that can be used in an airbag apparatus or the like.

2. Description of Related Art

In a housing 103 forming an outer shell of a gas generator 100 shown in FIG. 3, a diffuser shell 101 having a gas discharge port 104 and a closures shell 102 are integrated by welding at flange portions thereof.

A cylindrical coolant/filter 105 for cooling and filtering gas generated by combustion of a gas generating agent is disposed inside the housing 103. The coolant/filter 105 is disposed in a state in which both end surfaces thereof are pressed against annular inclined surfaces 106, 107 formed in the top surface and bottom surface of the housing respectively.

In the gas generator shown in FIG. 3, an annular coolant support 108 has to be disposed to fix the coolant/filter 105 so that it cannot move inward in the radial direction.

U.S. Pat. No. 6,647,277 discloses an inflator of a long-axis cylinder type for a driver side. This inflator has convex portions (annular crimps) 60, 62, but when the annular crimps 60, 62 are formed, they have to be formed after inserting a partition wall into the housing 12. As a result, the number of processing operations is increased. Further, as described in U.S. Pat. No. 6,647,277, a convex portion is formed in the inward direction by applying a force from the outside of the housing 12, but in this case because there is no die for controlling the formation of convex portions from the inner side, it is impossible to obtain a constant shape of the convex portions that are formed.

### SUMMARY OF INVENTION

The present invention provides:

a gas generator including an igniter, a gas generating agent and a coolant/filter in a housing,

a positioning portion for the coolant/filter, which is formed in advance into a convex shape on the inward side of the housing and that is provided at least in either of the top surface or the bottom surface of the housing,

the coolant/filter being positioned by the positioning portion.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 shows a longitudinal sectional view of the gas generator in accordance with the present invention;

FIG. 2 shows an explanatory drawing of a positioning portion in the gas generator of another embodiment; and

FIG. 3 shows a longitudinal sectional view of the gas generator of the conventional art.

### DETAILED DESCRIPTION OF INVENTION

The coolant/filter can be positioned (the positioning includes determining the attachment position and fixing in this position) by using a coolant support, but the problem associated with this approach is that the number of parts increases, the number of processing steps increased, and the weight of the entire structure increases.

The present invention provides a gas generator in which the coolant/filter can be positioned with a simple structure, without using a coolant support for positioning the coolant/filter.

Forming a positioning portion that is formed into a convex shape on the inward side of the housing at least in either of the top surface or the bottom surface of the housing and positioning the coolant/filter with the positioning portion make the conventional coolant support unnecessary.

The present invention further provides the gas generator, wherein the positioning portion is an annular projection or a combination of a plurality of independent projections formed into a convex shape on the inward side of the housing in the top surface of the housing.

The positioning portion can be an annular protrusion or a combination of a plurality of independent projections (about three to ten independent projections) disposed equidistantly on the entire circumference.

The present invention further provides the gas generator, wherein the positioning portion is formed by pressing the housing in the predetermined position from the outside.

Because the positioning portion can be easily formed by a method of pressing the housing from the outside, the positioning portion can be formed in the process of press-forming the housing, without substantial changes in the conventional manufacturing line (that is, the number of processing steps is substantially the same).

The present invention further provides the gas generator, wherein the positioning portion is an annular projection formed into a convex shape on the inward side of the housing in the upper surface of the housing and has functions of positioning the coolant/filter and preventing a short-path through which combustion residues leak from a contact portion of the coolant/filter and an inner surface of the housing.

By forming the positioning portion as an annular projection, it is possible to demonstrate a short-path prevention function of preventing the combustion residues from getting to the outside of the gas generator, in addition to the coolant/filter positioning function.

The gas generator in accordance with the present invention is suitable for airbag apparatuses, and more particularly as a gas generator of a disk shape that can be used for a driver side.

With the gas generator in accordance with the present invention, the number of parts can be reduced, the number of processing operations can be substantially reduced, and the weight of the entire structure can be also reduced.

### PREFERABLE EMBODIMENT OF INVENTION

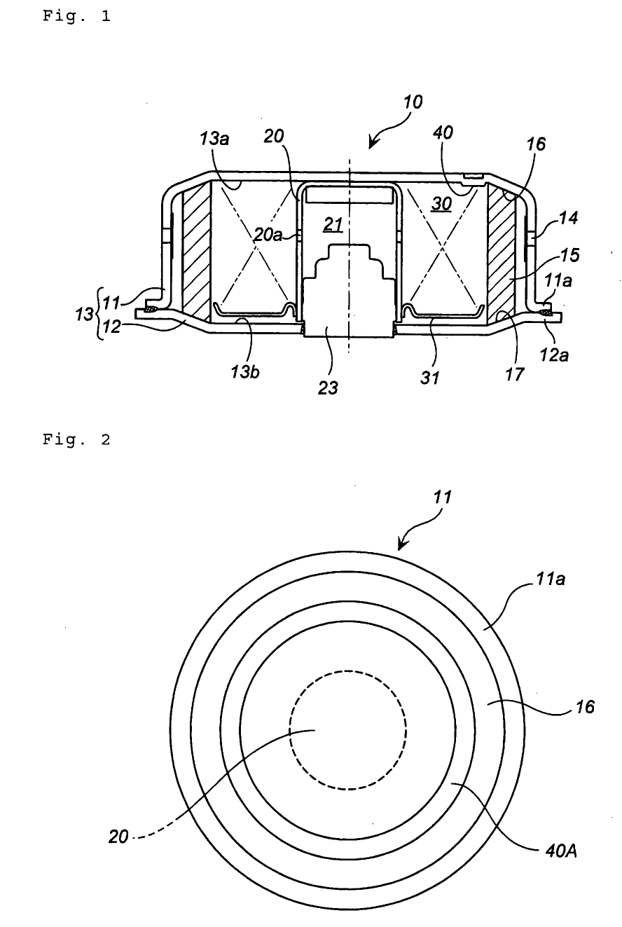

An embodiment of the present invention will be described below based on FIG. 1. FIG. 1 is a longitudinal sectional view of the gas generator 10 in accordance with the present invention.

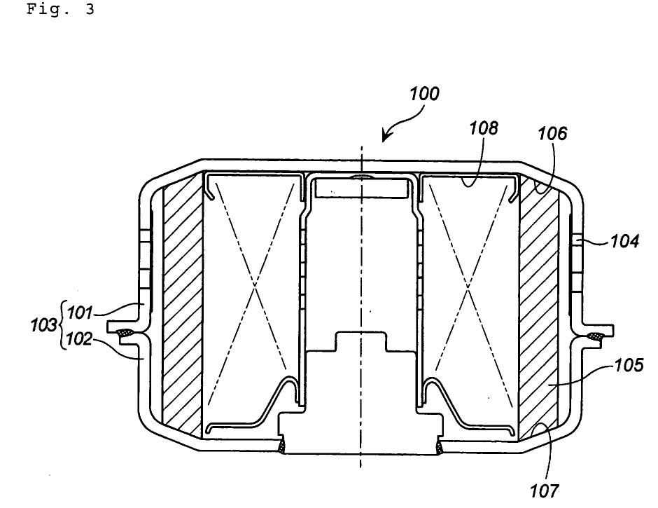

FIG. 2 is a planar view, as viewed from the inside, of a housing (diffuser shell) showing the positioning portion of another embodiment.

In a housing 13 forming an outer shell of a gas generator 10 shown in FIG. 1, a diffuser shell 11 having a gas discharge port 14 and a closure shell 12 are integrated by welding at flange portions 11a, 12a thereof.

A cylindrical coolant/filter 15 for cooling and filtering the gas generated by combustion of a gas generating agent is disposed inside the housing 13. The coolant/filter 15 is disposed in a state in which both end surfaces thereof are pressed against an upper annular inclined surface 16 and a lower annular inclined surface 17 formed at a top surface 13a and a bottom surface 13b of the housing respectively.

An inner tube 20 having a flame transferring hole 20a in a circumferential wall is disposed in the central portion inside the housing 13, and the inside of the inner tube serves as an ignition device chamber 21. An electric igniter 23 fixed to an igniter collar is accommodated inside the ignition device chamber 21, and the remaining space is filled with a known transfer charge (not shown in the drawing).

The outside of the inner tube 20 is a combustion chamber 30 that is filled with a gas generating agent (not shown in the drawing). A retainer 31 for adjusting the volume according to the filled quantity of the gas generating agent is disposed in the housing bottom surface 13b side inside the combustion chamber 30.

The housing top surface 13a inside the combustion chamber 30 has a positioning portion 40 for a coolant/filter that is formed in advance into a convex shape on the inward side of the housing. The positioning portion 40 shown in FIG. 1 includes a combination of a plurality of independent projections (three to twelve independent projections) that are disposed equidistantly over the entire circumference. The positioning portion 40 is formed at the same time as the housing 13 is molded, by selectively using a metal die that can form the positioning portion 40 when the housing 13 is press molded.

By providing such a positioning portion 40, when the two end surfaces of the coolant/filter 15 are disposed inside the housing 13 so as to abut against the upper annular inclined surface 16 and lower annular inclined surface 17 respectively, the coolant/filter is prevented from moving toward the gas discharge port 14 by the difference in height between the coolant/filter 15 and the housing 13 and also prevented from moving in the direction of inner tube 20 by the positioning portion 40. As a result, the coolant/filter can be easily positioned.

In addition, as shown in FIG. 2, by forming a positioning portion 40A formed of an annular projection, in addition to positioning the coolant/filter 15, the short-path prevention effect of preventing the combustion gas generated inside the combustion chamber 30 from leaking from the contact portion of the coolant/filter 15 and housing top surface 13a can be enhanced.

The gas generators equipped with the positioning portions 40, 40A shown in FIG. 1 and FIG. 2 can be formed by the conventional manufacturing process. Therefore, there is essentially no increase in the number of processing operations. Further, because the positioning portions 40, 40A can be formed using two, upper and lower, metal dies when the diffuser shell 11 is press-molded, the convex portions of desired shape can be formed with good reproducibility. As a result, the positioning can be performed more accurately than with the conventional technology. Moreover, the coolant support for fixing the coolant/filter 15 such as was necessary in the conventional technology is not required. Therefore, the number of parts and processing operations can be reduced and the weight of the entire structure can be also reduced.

The gas generator in accordance with the present invention can be employed, for example, as a gas generator for an airbag for a driver side, a gas generator for an airbag for a passenger side, a gas generator for a side airbag, a gas generator for an inflatable curtain, a gas generator for a knee bolster, a gas generator for an inflatable seat belt, a gas generator for a tubular system, and a gas generator for a pretensioner for a variety of vehicles, but is especially suitable as a gas generator for an air bag for a driver side.

The invention thus described, it will be obvious that the same may be varied in many ways. Such variations are not to be regarded as a departure from the spirit and scope of the invention, and all such modifications as would be obvious to on skilled in the art are intended to be included within the scope of the following claims.

1. A gas generator comprising an igniter, a gas-generating agent and a coolant/filter in a housing,
a positioning portion for the coolant/filter, which is formed in advance into a convex shape on the inward side of the housing and that is provided at least in either of the top surface or the bottom surface of the housing,
the coolant/filter being positioned by the positioning portion.

2. The gas generator according to claim 1, wherein the positioning portion is an annular projection or a combination of a plurality of independent projections formed into a convex shape on the inward side of the housing in the top surface of the housing.

3. The gas generator according to claim 1, wherein the positioning portion is formed by pressing the housing in the predetermined position from the outside.

4. The gas generator according to claim 1, wherein the positioning portion is an annular projection formed into a convex shape on the inward side of the housing in the upper surface of the housing and has functions of positioning the coolant/filter and preventing a short-path through which combustion residues leak from a contact portion of the coolant/filter and an inner surface of the housing.

5. The gas generator according to claim 1, which is a gas generator in a disk shape.

6. The gas generator according to claim 2, wherein the positioning portion is formed by pressing the housing in the predetermined position from the outside.

7. The gas generator according to claim 2, wherein the positioning portion is an annular projection formed into a convex shape on the inward side of the housing in the upper surface of the housing and has functions of positioning the coolant/filter and preventing a short-path through which combustion residues leak from a contact portion of the coolant/filter and an inner surface of the housing.

8. The gas generator according to claim 2, which is a gas generator in a disk shape.
